(19) United States
(12) Patent Application Publication
(10) Pub. No.: US 2017/0147126 A1
(43) Pub. Date: May 25, 2017

(54) TOUCH PANEL

(71) Applicant: AU OPTRONICS CORPORATION, Hsin-chu (TW)

(72) Inventors: KUAN-YU CHIU, Hsin-chu (TW); TENG-FU TUNG, Hsin-chu (TW); PO-YUAN LIU, Hsin-chu (TW); YUNG-TSE CHENG, Hsin-chu (TW)

(21) Appl. No.: 15/181,965

(22) Filed: Jun. 14, 2016

(30) Foreign Application Priority Data
Nov. 23, 2015 (TW) 104138840

(51) Int. Cl. G06F 3/041; G06F 3/044

(52) U.S. Cl. CPC G06F 3/0416; G06F 3/0412; G06F 3/044; G06F 2203/04111; G06F 2203/04112

(57) ABSTRACT

A touch panel including a substrate, first bridge electrodes, first transparent electrodes, an insulation layer, first sensing electrodes, second bridge electrodes, and second sensing electrodes is provided. Two neighboring first transparent electrodes cover two ends of each first bridge electrode and are electrically connected to the first bridge electrode. Each first transparent electrode has an overlapping region and a non-overlapping region. The insulation layer has openings. Two neighboring openings expose the non-overlapping regions of the first transparent electrodes. Two neighboring first sensing electrodes are filled in the openings and are electrically connected to each other through the first transparent electrodes and the first bridge electrodes, so as to form a first sensing electrode series. The second bridge electrodes cross the first bridge electrodes. Two neighboring second sensing electrodes are connected to two ends of each second bridge electrode, so as to form a second sensing electrode series.

### CROSS-REFERENCE TO RELATED APPLICATIONS

This non-provisional application claims priority under 35 U.S.C. §119(a) on Patent Application No. 104138840 filed in Taiwan, R.O.C. on Nov. 23, 2015, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE DISCLOSURE

The present disclosure relates generally to an electronic device, and in particular, to a touch panel that has improved reliability.

### BACKGROUND OF THE DISCLOSURE

Generally, in consideration of the electrical conductivity of touch panels, bridge electrodes in touch panels are mostly made of a non-light-transmissive material. Because the bridge electrode is not light-transmissive, the bridge electrode is usually designed to have a small area in order to ensure the transmissivity and visual effect. As a result, the opening of an insulation layer for exposing the bridge electrode has a small area, and a side wall of the insulation layer that defines the opening has a steep slope of, for example, greater than 70°. Consequently, during a reliability test for the touch panel, the side wall of the insulation layer and a sensing electrode laid on the side wall are prone to collapse, leading to failure of the touch panel.

### SUMMARY

In one aspect, the present disclosure relates to a touch display panel with improved reliability.

In certain embodiments, the touch panel includes a substrate, a plurality of first bridge electrodes, a plurality of first transparent electrodes, a first insulation layer, a plurality of first sensing electrodes, a plurality of second bridge electrodes, and a plurality of second sensing electrodes. The substrate has a touch region and a peripheral region surrounding the touch region. The first bridge electrodes are disposed on the touch region of the substrate. The first transparent electrodes are separated from each other and are disposed on the touch region of the substrate. Two neighboring first transparent electrodes respectively cover two ends of corresponding one of the first bridge electrodes and are electrically connected to the corresponding one of the first bridge electrodes. Each of the first transparent electrodes has an overlapping region that overlaps with the corresponding first bridge electrode and a non-overlapping region that does not overlap with the corresponding first bridge electrode. The first insulation layer covers the first bridge electrodes, the first transparent electrodes, and the substrate. The first insulation layer has a plurality of first openings. Two neighboring first openings respectively expose a part of the corresponding two neighboring first non-overlapping regions of the first transparent electrodes. The first sensing electrodes are disposed on the first insulation layer and are located on the touch region of the substrate. Two neighboring first sensing electrodes respectively overlap with two ends of corresponding one of the first bridge electrodes and two neighboring first transparent electrodes. The two neighboring first sensing electrodes are respectively filled in the first openings and are electrically connected to each other through the first transparent electrodes exposed by the first openings and the first bridge electrode, so as to form a first sensing electrode series extending in a first direction. The second bridge electrodes are disposed on the first insulation layer and are located on the touch region of the substrate. The second bridge electrodes respectively cross the first bridge electrodes. The second sensing electrodes are disposed on the first insulation layer and are located on the touch region of the substrate. Two neighboring second sensing electrodes are respectively connected to two ends of corresponding one of the second bridge electrodes, so as to form a second sensing electrode series extending in a second direction. The first direction intersects with the second direction.

In an embodiment of the present disclosure, the first insulation layer further has a plurality of second openings separated from the first openings. Two neighboring second openings respectively expose a part of the first overlapping regions of the first transparent electrodes. The first sensing electrodes are further filled in the second openings respectively, so as to be electrically connected to each other through the first transparent electrodes exposed by the second openings and the corresponding one of the first bridge electrodes.

In an embodiment of the present disclosure, the area of each of the first openings is greater than the area of each of the second openings.

In an embodiment of the present disclosure, the first insulation layer has a bottom surface that faces the substrate, a first side wall that defines the first opening, and a second side wall that defines the second opening. A first angle is formed between the first side wall and the bottom surface. A second angle is formed between the second side wall and the bottom surface. The first angle is smaller than the second angle.

In an embodiment of the present disclosure, each of the first openings exposes the first overlapping region and the first non-overlapping region of the corresponding first transparent electrode.

In an embodiment of the present disclosure, the touch panel further includes a conductive electrode, a trace, and a second transparent electrode. The conductive electrode and the trace are located on the peripheral region. The conductive electrode is electrically connected between the first sensing electrode series and the trace or is electrically connected between the second sensing electrode series and the trace. The second transparent electrode is located on the peripheral region. The second transparent electrode covers the conductive electrode and is electrically connected to the conductive electrode. The second transparent electrode has a second overlapping region that overlaps with the conductive electrode and a second non-overlapping region that does not overlap with the conductive electrode. The first insulation layer further has a third opening. The third opening exposes a part of the second non-overlapping region of the second transparent electrode. The first sensing electrode or the second sensing electrode is filled in the third opening, and is electrically connected to the trace through the second transparent electrode exposed by the third opening and the conductive electrode.

In an embodiment of the present disclosure, the first insulation layer further has at least one fourth opening separated from the third openings. The fourth opening exposes a part of the second overlapping region of the second transparent electrode. The first sensing electrode or the second sensing electrode is further filled in the fourth opening, so as to be electrically connected to the trace through the second transparent electrode exposed by the fourth opening and the conductive electrode.

In an embodiment of the present disclosure, the area of the third opening is greater than the area of the fourth opening.

In an embodiment of the present disclosure, the first insulation layer has a bottom surface that faces the substrate, a third side wall that defines the third opening, and a fourth side wall that defines the fourth opening. A third angle is formed between the third side wall and the bottom surface. A fourth angle is formed between the fourth side wall and the bottom surface. The third angle is smaller than the fourth angle.

In an embodiment of the present disclosure, the third opening exposes the second overlapping region and the second non-overlapping region of the second transparent electrode.

Another touch panel of the present disclosure includes a substrate, a conductive electrode, a trace, a transparent electrode, a first insulation layer, a bridge electrode, and a plurality of sensing electrodes. The substrate has a touch region and a peripheral region surrounding the touch region. The conductive electrode and the trace are disposed on the peripheral region of the substrate. One end of the trace is connected to the conductive electrode. The transparent electrode is disposed on the peripheral region of the substrate. The transparent electrode covers the conductive electrode and is electrically connected to the conductive electrode. The transparent electrode has an overlapping region that overlaps with the conductive electrode and a non-overlapping region that does not overlap with the conductive electrode. The first insulation layer covers the conductive electrode, the trace, the transparent electrode, and the substrate. The first insulation layer has a first opening. The first opening exposes a part of the non-overlapping region of the transparent electrode. The bridge electrode is disposed on the first insulation layer and is located on the touch region of the substrate. The sensing electrodes are disposed on the first insulation layer and are located on the touch region of the substrate. One of the sensing electrodes corresponding to the conductive electrode is filled in the first opening, so as to be electrically connected to the trace through the transparent electrode exposed by the first opening and the conductive electrode. Two neighboring sensing electrodes are connected through the bridge electrode, so as to form a sensing electrode series.

In an embodiment of the present disclosure, the first insulation layer further has a second opening separated from the first opening. The second opening exposes the overlapping region of the transparent electrode. One of the sensing electrodes corresponding to the conductive electrode is further filled in the second opening, so as to be electrically connected to the trace through the transparent electrodes exposed by the second openings and the conductive electrode.

In an embodiment of the present disclosure, the area of the first opening is greater than the area of the second opening.

In an embodiment of the present disclosure, the first insulation layer has a bottom surface that faces the substrate, a first side wall that defines the first opening, and a second side wall that defines the second opening. A first angle is formed between the first side wall and the bottom surface. A second angle is formed between the second side wall and the bottom surface. The first angle is smaller than the second angle.

In an embodiment of the present disclosure, the first opening exposes the overlapping region and the non-overlapping region of the transparent electrode.

Based on the above, in the touch panel according to one embodiment of the present disclosure, two ends of each of the first bridge electrodes are respectively covered by two transparent electrodes, and each of the transparent electrodes has a part extending out of the first bridge electrode. The openings are provided above the part of the transparent electrode that extends out of the first bridge electrode. Through the configuration of the transparent electrodes, the area of the openings for electrically connecting two neighboring first sensing electrodes is not limited by the size of the first bridge electrode. Thereby, the area of the openings can be designed larger, i.e., the side wall that defines the opening can be designed to have a gentle slope of, for example, smaller than 70°. In this way, when two neighboring first sensing electrodes are filled in the openings and electrically connected to each other, the first sensing electrodes can be desirably laid on the side wall having a gentle slope. Because the side wall and the first sensing electrodes laid on the side wall are not prone to collapse, the reliability of the touch panel can be improved.

In another aspect of the present disclosure, a touch display panel is provided. In certain embodiments, the touch panel includes a trace located in the peripheral region and a conductive electrode located in the peripheral region and electrically connected to the trace. The conductive electrode is used to be electrically connected to the first sensing electrodes of the first sensing electrode series or the second sensing electrodes of the second sensing electrode series. The touch panel further includes a transparent electrode. The transparent electrode covers the conductive electrode and has a part extending out of the conductive electrode. The openings can be provided above the part of the transparent electrode that extends out of the conductive electrode. Through the configuration of the transparent electrode, the area of the openings for electrically connecting the first sensing electrodes (or the second sensing electrodes) to the conductive electrode is not limited by the size of the conductive electrode. Thereby, the area of the openings may be designed larger, i.e., the side wall that defines the opening can be designed to have a gentle slope of, for example, smaller than 70°. In this way, when the first sensing electrodes (or the second sensing electrodes) are filled in the openings and electrically connected to the trace, the first sensing electrodes (or the second sensing electrodes) can be desirably laid on the side wall having a gentle slope. Because the side wall is not prone to collapse, the reliability of the touch panel can be improved.

In order to make the aforementioned features and advantages of the present disclosure comprehensible, embodiments accompanied with figures are described in detail below.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a schematic top view of a touch panel according to an embodiment of the present disclosure.

FIG. 2 is a partial schematic view of a touch region of the touch panel according to an embodiment of the present disclosure.

FIG. 3 is an enlarged view of a region R1 in FIG. 2.

FIG. 4 is a schematic cross-sectional view of the touch panel taken along a cross-sectional line A-A′ in FIG. 3.

FIG. 5 is a schematic top view of a touch panel according to another embodiment of the present disclosure.

FIG. 6 is a partial schematic view of a touch region of the touch panel in FIG. 5.

FIG. 7 is an enlarged view of a region R2 in FIG. 6.

FIG. 8 is a schematic cross-sectional view of the touch panel taken along a cross-sectional line B-B′ in FIG. 7.

FIG. 9 is a partial schematic view of a touch panel according to an embodiment of the present disclosure.

FIG. 10 is a schematic enlarged view of a region K1 in FIG. 9.

FIG. 11 is a schematic cross-sectional view of the touch panel taken along a cross-sectional line C-C′ in FIG. 10.

FIG. 12 is a schematic enlarged view of a partial region K2 in FIG. 9.

FIG. 13 is a schematic cross-sectional view of the touch panel taken along a cross-sectional line D-D′ in FIG. 12.

FIG. 14 is a partial schematic view of the touch panel according to an embodiment of the present disclosure.

FIG. 15 is a schematic enlarged view of a region K3 in FIG. 14.

FIG. 16 is a schematic cross-sectional view of the touch panel taken along a cross-sectional line E-E′ in FIG. 15.

FIG. 17 is a schematic enlarged view of a region K4 in FIG. 14.

FIG. 18 is a schematic cross-sectional view of the touch panel taken along a cross-sectional line F-F′ in FIG. 17.

### DETAILED DESCRIPTION OF THE DISCLOSURE

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

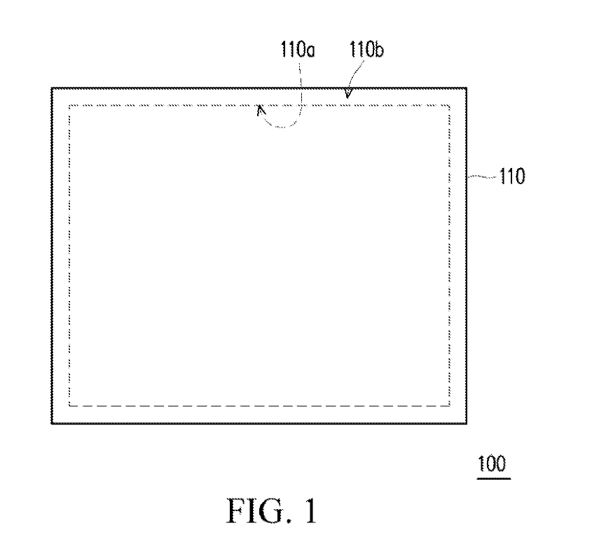

The description will be made as to the embodiments of the present invention in conjunction with the accompanying drawings in FIGS. 1-18. In accordance with the purposes of this invention, as embodied and broadly described herein, this invention, in one aspect, relates to a touch panel.

FIG. 1 is a schematic top view of a touch panel according to an embodiment of the present disclosure. Referring to FIG. 1, a touch panel 100 includes a substrate 110. The substrate 110 has a touch region 110a and a peripheral region 110b outside or surrounding the touch region 110a. The peripheral region 110b includes a trace region for disposing traces. In other embodiments, the touch region 110a may extend to at least a part of the peripheral region 110b to overlap with at least a part of the peripheral region 110b. In this case, the touch region 110a may be referred to as a main touch region, and the peripheral region 110b may be referred to as an auxiliary touch region. It should be noted that the peripheral region 110b can be referred to as an auxiliary touch region only when the touch region 110a can be referred to as a main touch region, i.e., the peripheral region 110b referred to as an auxiliary touch region cannot exist alone. In this embodiment, the material of the substrate 110 is, for example, glass, but the present disclosure is not limited thereto. In other embodiments, the material of the substrate 110 may also be quartz, an organic polymer, such as polyimide (PI), polyethylene terephthalate (PET) or polyethylene naphthalate (PEN), or any other suitable material.

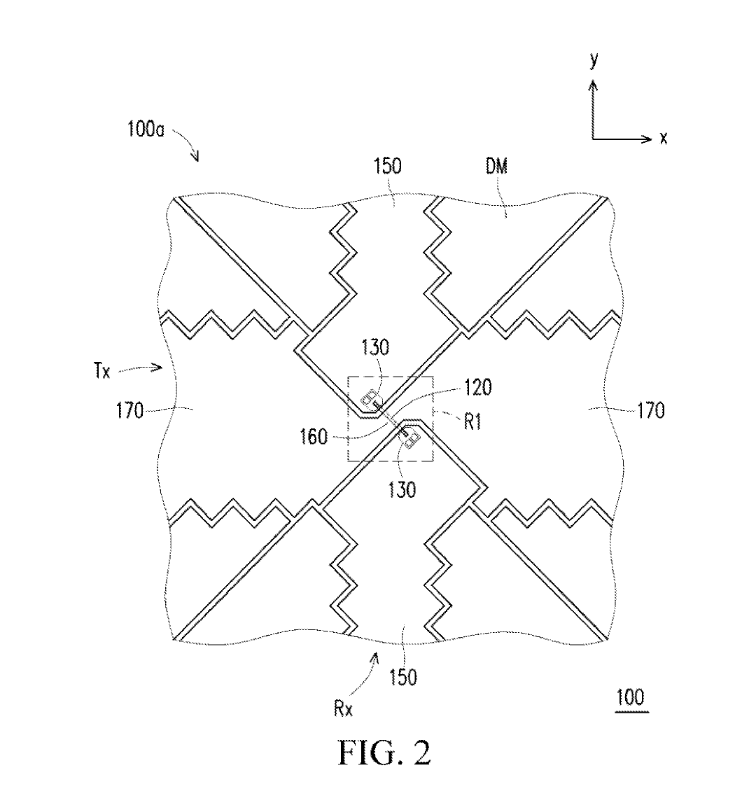

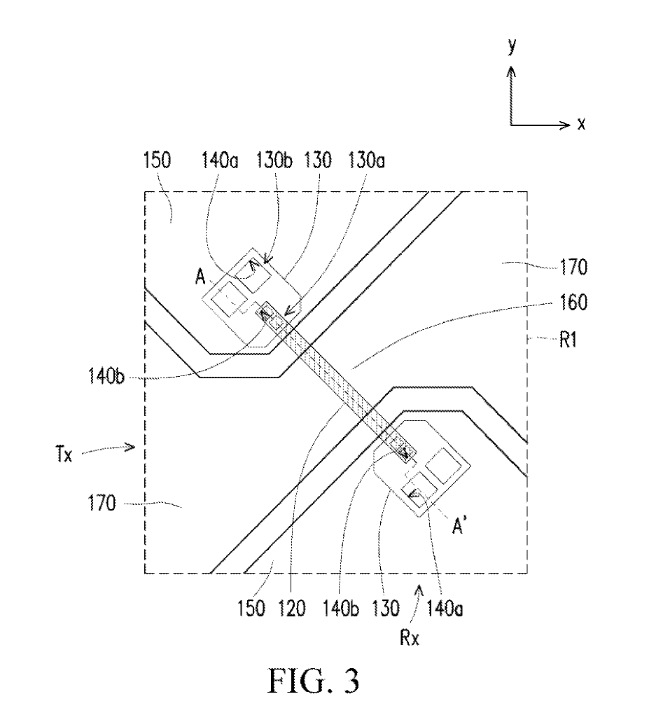

FIG. 2 is a partial schematic view of a touch region of the touch panel according to an embodiment of the present disclosure. FIG. 3 is an enlarged view of a region R1 in FIG. 2. Referring to FIGS. 2 and 3, the touch panel 100 further includes a plurality of first bridge electrodes 120. The plurality of first bridge electrodes 120 is arranged as an array on the touch region 110a of the substrate 110. Although FIGS. 2 and 3 merely show one first bridge electrode 120 as an example, a person of ordinary skill in the art can implement the plurality of first bridge electrodes 120 according the above description and corresponding drawings. In this embodiment, the first bridge electrodes 120 may be made of a metal, but the present disclosure is not limited thereto. In other embodiments, the first bridge electrodes 120 may also be made of other suitable electrically conductive materials.

Referring to FIGS. 2 and 3, the touch panel 100 further includes a plurality of transparent electrodes 130. The transparent electrodes 130 are separated from each other and are disposed on the touch region 110a of the substrate 110. As shown in FIG. 3, two neighboring transparent electrodes 130 respectively cover two ends of the corresponding first bridge electrodes 120 and are electrically connected to the first bridge electrode 120. Each of the transparent electrodes 130 has an overlapping region 130a that overlaps with the first bridge electrode 120 and a non-overlapping region 130b that does not overlap with the first bridge electrode 120. In this embodiment, two neighboring transparent electrodes 130 directly cover the two ends of each of the first bridge electrodes 120 and are thus connected to or in direct contact with the first bridge electrode 120, but the present disclosure is not limited thereto. The material of the transparent electrodes 130 may be indium tin oxide, indium zinc oxide, aluminum tin oxide, aluminum zinc oxide, indium germanium zinc oxide, carbon nanotube, graphene, nano silver, a mesh of electrically conductive material, or a stack layer of at least two of the above materials, but the present disclosure is not limited thereto.

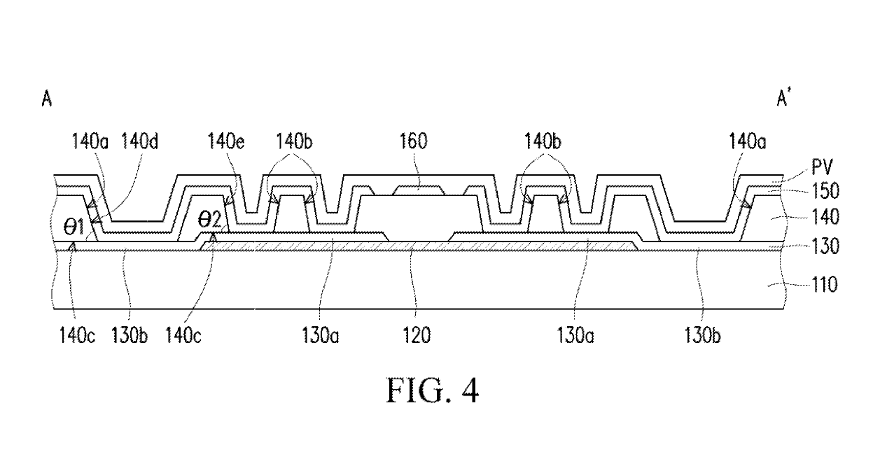

FIG. 4 is a schematic cross-sectional view of the touch panel taken along a cross-sectional line A-A′ in FIG. 3. Referring to FIGS. 3 and 4, the touch panel 100 further includes an insulation layer 140. The material of the insulation layer 140 may be an inorganic material (for example, silicon oxide, silicon nitride, silicon oxynitride, or a stack layer of at least two of the above materials), an organic material, or a stack layer thereof. The insulation layer 140 covers the first bridge electrodes 120, the transparent electrodes 130, and the substrate 110. The insulation layer 140 has a plurality of openings 140a. Two neighboring openings 140a in the length direction of the first bridge electrodes 120 respectively expose a part of the non-overlapping regions 130b of two neighboring transparent electrodes 130. The non-overlapping region 130b of each of the transparent electrodes 130 is at least exposed by one of the openings 140a.

In this embodiment, the openings 140a expose the non-overlapping regions 130b of the transparent electrodes 130, and may selectively not expose the overlapping regions 130a of the transparent electrodes 130. In certain embodiments, the insulation layer 140 may selectively have a plurality of openings 140b separated from the openings 140a. Two neighboring openings 140b respectively expose a part of the overlapping regions 130a of the two neighboring transparent electrodes 130. However, the present disclosure is not limited thereto, and in other embodiments, the openings 140a may also expose both the non-overlapping regions 130b and the overlapping regions 130a of the transparent electrodes 130, and correspondingly, the configuration of the openings 140b can be omitted, which will be illustrated in the following paragraphs with reference to other drawings.

Referring to FIGS. 2, 3, and 4, the touch panel 100 further includes a plurality of first sensing electrodes 150 disposed on the first insulation layer 140 and the touch region 110a of the substrate 110. As shown in FIGS. 3 and 4, two neighboring first sensing electrodes 150 respectively overlap with two ends of each of the first bridge electrodes 120 and the corresponding two neighboring transparent electrodes 130. The two neighboring first sensing electrodes 150 are further filled in the corresponding openings 140a respectively and are electrically connected to each other through the corresponding two transparent electrodes 130 exposed by the openings 140a and the corresponding bridge electrode 120, i.e., each of the first sensing electrodes 150 is connected to or in direct contact with the corresponding transparent electrode 130 through the corresponding opening 140a and is thus electrically connected to the corresponding bridge electrode 120, so as to form a first sensing electrode series (or namely string) Rx extending in a direction y. The first sensing electrodes 150 may have a single-layer or multi-layer structure and may be made of a material selected from the material of the transparent electrodes 130 (in this case, the first sensing electrodes may also be referred to as first transparent sensing electrodes), and the material of the first sensing electrodes 150 may be substantially the same as or different from that of the transparent electrodes 130.

Referring to FIGS. 3 and 4, in this embodiment, two neighboring first sensing electrodes 150 are further filled in the corresponding openings 140b respectively, so as to be electrically connected to each other through the transparent electrodes 130 exposed by the openings 140b and the first bridge electrode 120, i.e., each of the first sensing electrodes 150 is further connected to or in direct contact with the corresponding transparent electrode 130 through the corresponding opening 140b and is thus electrically connected to the bridge electrode 120. The area (or namely vertical projection area) of each of the openings 140a may be greater than that of each of the openings 140b. As shown in FIG. 4, the insulation layer 140 has a bottom surface 140c that faces the substrate 110, a side wall 140d that defines the opening 140a, and a side wall 140e that defines the opening 140b. An angle θ1 is formed between the side wall 140d and the bottom surface 140c. An angle θ2 is formed between the side wall 140e and the bottom surface 140c. The angle θ1 is smaller than the angle θ2. In other words, the taper angle (i.e., θ1) of the opening 140a corresponding to a larger area is smaller than the taper angle (i.e., θ2) of the opening 140b corresponding to a smaller area. In certain embodiments, the angle θ1 is smaller than 70° and greater than 0°. In one embodiment, the angle θ1 is smaller than 65° and greater than 30°. In one embodiment, the angle θ1 is smaller than 55° and greater than 30°.

Referring to FIGS. 2, 3, and 4, the touch panel 100 further includes a plurality of second bridge electrodes 160 and a plurality of second sensing electrodes 170. The second bridge electrodes 160 and the second sensing electrodes 170 are disposed on the insulation layer 140 and the touch region 110a of the substrate 110. Each of the second bridge electrodes 160 crosses the corresponding one of the first bridge electrodes 120. Two neighboring second sensing electrodes 170 are respectively connected to two ends of the corresponding second bridge electrode 160, so as to form a second sensing electrode series (or namely string) Tx extending in a direction x. The direction x intersects with the direction y. A protective layer PV covers the first sensing electrode string Rx and the second sensing electrode string Tx. The second sensing electrodes 170 may have a single-layer or multi-layer structure and may be made of a material selected from the material of the transparent electrodes 130 (in this case, the second sensing electrodes may also be referred to as second transparent sensing electrodes), and the material of the second sensing electrodes 170 may be substantially the same as or different from that of the transparent electrodes 130. The second bridge electrodes 160 may have a single-layer or multi-layer structure and may be made of a material selected from the material of the first bridge electrodes 120 or the transparent electrodes 130. In this embodiment, the first sensing electrodes 150, the second bridge electrodes 160, and the second sensing electrodes 170 may selectively belong to a same film layer, i.e., the first sensing electrodes 150, the second bridge electrodes 160, and the second sensing electrodes 170 may be made of a same material, but the present disclosure is not limited thereto. In addition, as shown in FIG. 2, in this embodiment, the touch panel 100 may selectively include a plurality of dummy sensing electrodes DM. The dummy sensing electrodes DM are filled in a gap between the first sensing electrode string Rx and the second sensing electrode string Tx, so as to improve the overall visual effect of the touch panel 100, i.e., enhance the uniformity of light transmission throughout the touch panel 100.

It should be noted that, as shown in FIG. 3, two ends of each of the first bridge electrodes 120 are respectively covered by two corresponding transparent electrodes 130, and each of the two corresponding transparent electrodes 130 has a part (i.e., the non-overlapping region 130b) extending out of the first bridge electrode 120. The opening 140a may be provided above the part of the transparent electrode 130 that extends out of the first bridge electrode 120. Through the configuration of the transparent electrode 130, the area of the openings 140a for electrically connecting two neighboring first sensing electrodes 150 is not limited by the size of the first bridge electrode 120. Thereby, the area of the openings 140a can be designed larger (i.e., the angle θ1 in FIG. 4 can be designed smaller). Referring to FIG. 4, in this way, when two neighboring first sensing electrodes 150 are filled in the corresponding openings 140a so as to be electrically connected to each other, the first sensing electrodes 150 can be desirably laid on the first side wall 140d having a gentle slope. Because the first side wall 140d is not prone to collapse, the reliability of the touch panel 100 can be improved. In addition, because the first transparent electrodes 130 that are used to improve the reliability of the touch panel 100 are light transmissive, the first transparent electrodes 130 will not affect the transmissivity of the touch panel 100. Therefore, a touch panel 100 having good reliability and optical quality can be provided.

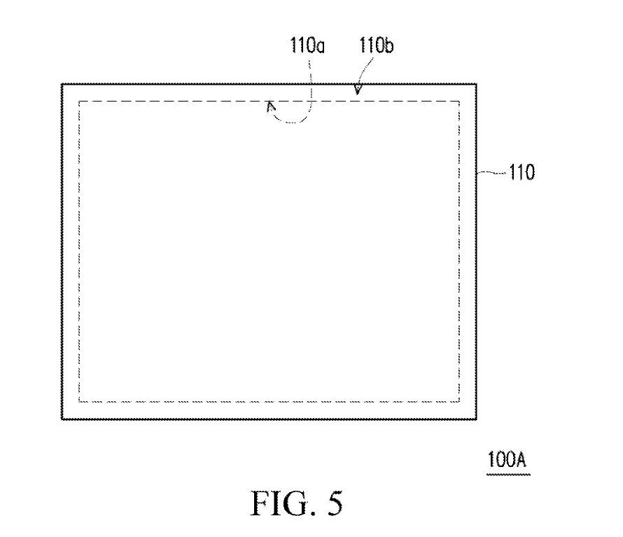

Referring to FIG. 4, further, in this embodiment, two neighboring first sensing electrodes 150 may be filled in the openings 140a and the openings 140b of the insulation layer 140, so as to be electrically connected to each other through the transparent electrodes 130 and the first bridge electrode 120, i.e., each of the first sensing electrodes 150 is connected to or in direct contact with the corresponding transparent electrode 130 through the corresponding openings 140a and openings 140b respectively and is thus electrically connected to the first bridge electrode 120. Therefore, even if the side wall 140e having a steep slope collapses (or namely sharp slope collapses), the two neighboring first sensing electrodes 150 can still be filled in the openings 140a and electrically connected to each other, thereby improving the reliability of the touch panel 100. However, according to the present disclosure, the insulation layer 140 of the touch panel 100 may not necessarily have the openings 140b, and related descriptions are given below by way of example with reference to FIG. 5 to FIG. 8.

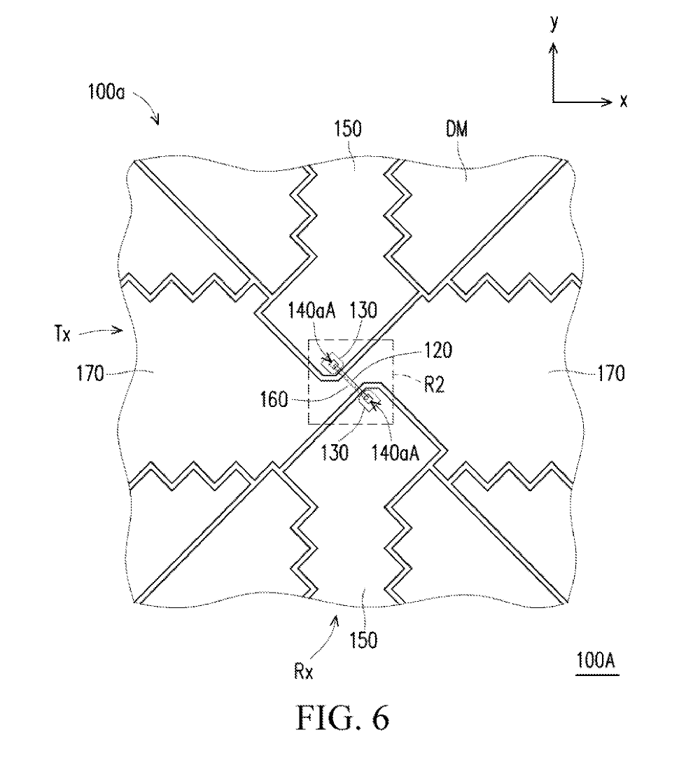

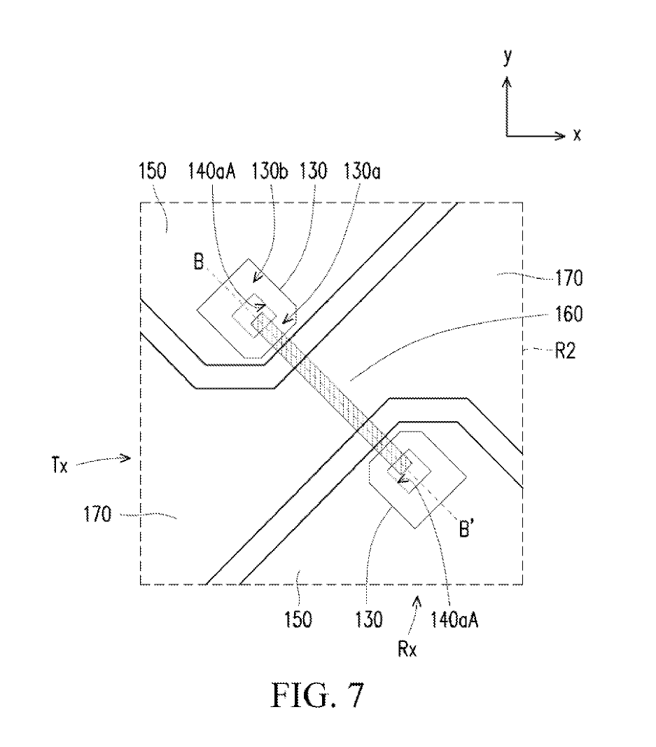

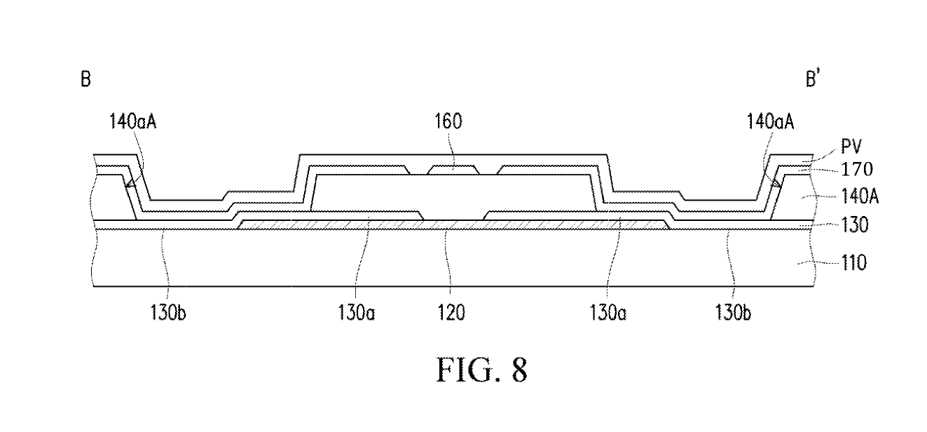

FIG. 5 is a schematic top view of a touch panel according to another embodiment of the present disclosure. FIG. 6 is a partial schematic view of a touch region 110a of a touch panel 100A in FIG. 5. FIG. 7 is an enlarged view of a region R2 in FIG. 6. FIG. 8 is a schematic cross-sectional view of the touch panel taken along a cross-sectional line B-B′ in FIG. 7. The touch panel 100A in FIG. 5 to FIG. 8 is similar to the touch panel 100 in FIG. 1 to FIG. 4, and same or corresponding components are denoted by same or corresponding reference numerals. The main difference between the touch panel 100A and the touch panel 100 lies in that the range of the openings 140aA of the touch panel 100A is different from the range of the openings 140a of the touch panel 100. The following description is mainly about the difference between the two, and for the same parts of the two, reference can be made to the above description in accordance with the reference numerals in FIG. 5 to FIG. 8.

Referring to FIG. 5 to FIG. 8, the touch panel 100A includes a substrate 110, a plurality of first bridge electrodes 120, a plurality of transparent electrodes 130, an insulation layer 140A, a plurality of first sensing electrodes 150, a plurality of second bridge electrodes 160, and a plurality of second sensing electrodes 170. The substrate 110 has a touch region 110a and a peripheral region 110b outside the touch region 110a. The plurality of first bridge electrodes 120 is disposed on the touch region 110a of the substrate 110. The plurality of transparent electrodes 130 is separated from each other and is disposed on the touch region 110a of the substrate 110. Two neighboring transparent electrodes 130 respectively cover two ends of each of the first bridge electrodes 120 and are connected to or in direct contact with the corresponding first bridge electrode 120. Each of the transparent electrodes 130 has an overlapping region 130a that overlaps with the corresponding first bridge electrode 120 and a non-overlapping region 130b that does not overlap with the corresponding first bridge electrode 120. The insulation layer 140A covers the first bridge electrodes 120, the transparent electrodes 130, and the substrate 110. The insulation layer 140A has a plurality of openings 140aA. Two neighboring openings 140aA respectively expose a part of the non-overlapping regions 130b of the transparent electrodes 130. The plurality of first sensing electrodes 150 is disposed on the insulation layer 140A and is located on the touch region 110a of the substrate 110. Two neighboring first sensing electrodes 150 respectively overlap with two ends of each of the first bridge electrodes 120 and two neighboring transparent electrodes 130. Two neighboring first sensing electrodes 150 are respectively filled in the corresponding openings 140aA, and are electrically connected to each other through the corresponding transparent electrodes 130 exposed by the plurality of openings 140aA and the corresponding first bridge electrode 120, i.e., each of the first sensing electrodes 150 is connected or in direct contact with the corresponding transparent electrode 130 through the corresponding opening 140aA and is thus electrically connected to the corresponding first bridge electrode 120, so as to form a first sensing electrode series (or namely string) Rx extending in a direction y. The plurality of second bridge electrodes 160 is disposed on the insulation layer 140A and is located on the touch region 110a of the substrate 110. The second bridge electrodes 160 cross the first bridge electrodes 120. The plurality of second sensing electrodes 150 is disposed on the insulation layer 140A and is located on the touch region 110a of the substrate 110. Two neighboring second sensing electrodes 170 are respectively connected to two ends of each of the second bridge electrodes 160, so as to form a second sensing electrode series (or namely string) Tx extending in a direction x. The direction x intersects with the direction y.

Referring to FIGS. 7 and 8, the difference from the touch panel 100 lies in that, each of the first openings 140aA not only exposes the first non-overlapping region 130b of the corresponding first transparent electrode 130, but also exposes the first overlapping region 130a of the first transparent electrode 130. The openings 140aA have the functions of the openings 140a and the openings 140b of the touch panel 100 described above, so that the area (or namely vertical projection area) of the transparent electrodes 130 can be designed smaller, thereby further improving the visual effect (i.e., optical uniformity effect) of the touch panel 100A. In addition, the touch panel 100A has similar effects and advantages as compared with the touch panel 100, and the details will not be described herein again.

The inventive spirit of improving the reliability of the touch panel 100 by the use of the transparent electrodes 130 can also be applied to the electrical connection relationship between the first sensing electrode string Rx (and/or the second sensing electrode string Tx) and the trace 184. Descriptions are given below by way of example with reference to other drawings.

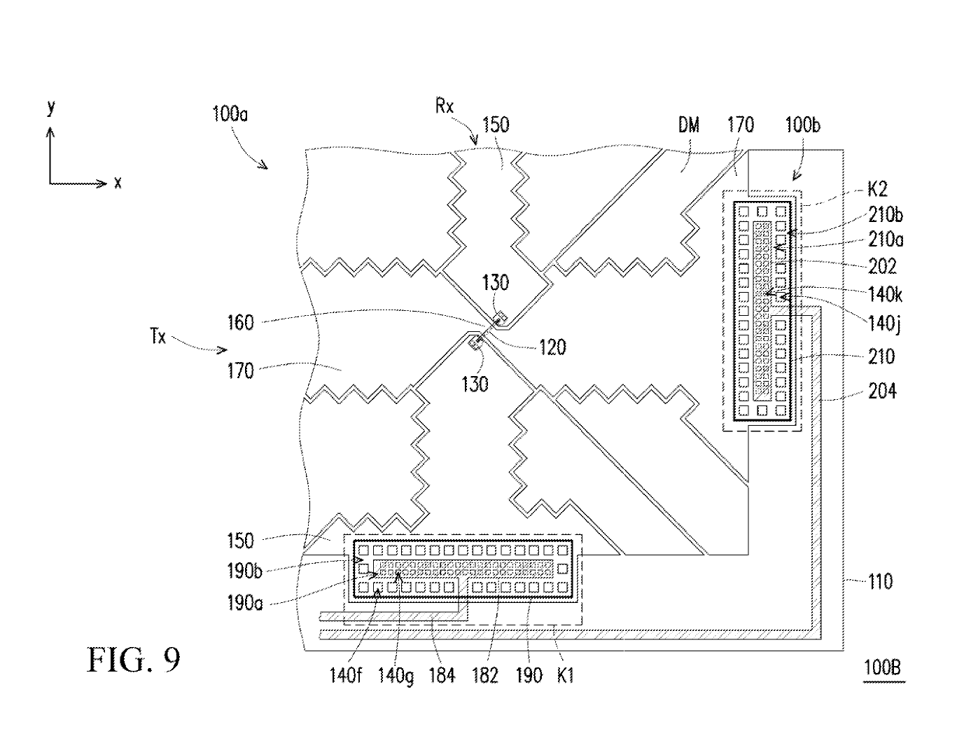

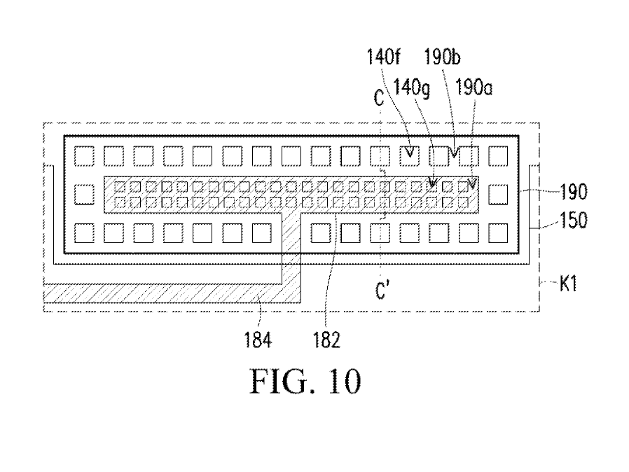

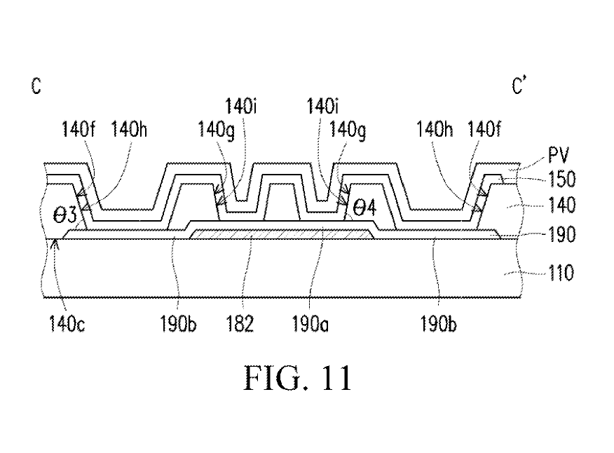

FIG. 9 is a partial schematic view of a touch panel according to an embodiment of the present disclosure. FIG. 10 is a schematic enlarged view of a region K1 in FIG. 9. FIG. 11 is a schematic cross-sectional view of the touch panel taken along a cross-sectional line C-C′ in FIG. 10. Referring to FIGS. 9, 10, and 11, a touch panel 100B includes the first sensing electrode series (or namely string) Rx and the second sensing electrode series (or namely string) Tx that are described above. For the structures of the first sensing electrode string Rx and the second sensing electrode string Tx, reference can be made to the above description, and the details are not described herein again. In addition to the first and second sensing electrode strings Rx and Tx, the touch panel 100B further includes a conductive electrode 182 and a trace 184 that are located on the peripheral region 110b. In this embodiment, the conductive electrode 182 and the trace 184 may be located in a same film layer and directly connected to each other. Further, the conductive electrode 182, the trace 184, and the first bridge electrodes 120 may be located in a same film layer, but the present disclosure is not limited thereto.

Referring to FIG. 9, FIG. 10, FIG. 11, the touch panel 100B further includes a transparent electrode 190 located on the peripheral region 110b. The transparent electrode 190 covers the conductive electrode 182 and is connected to or in direct contact with the conductive electrode 182. The transparent electrode 190 has an overlapping region 190a that overlaps with the conductive electrode 182 and a non-overlapping region 190b that does not overlap with the conductive electrode 182. The insulation layer 140 further has openings 140f The openings 140f expose a part of the non-overlapping region 190b of the transparent electrode 190. The first sensing electrodes 150 are filled in the openings 140f, so as to be electrically connected to the conductive electrode 182 and the trace 184 through the transparent electrode 190 exposed by the openings 140f, i.e., the first sensing electrodes 150 are connected to or in direct contact with the transparent electrode 190 through the corresponding openings 140f and are thus electrically connected to the conductive electrode 182 and the trace 184. In this embodiment, the transparent electrode 190 and the transparent electrode 130 may be located in a same film layer, but the present disclosure is not limited thereto.

In this embodiment, the insulation layer 140 may selectively further have openings 140g separated from the openings 140f The openings 140g exposes a part of the overlapping region 190a of the transparent electrode 190. The first sensing electrodes 150 are further filled in the openings 140g, so as to be electrically connected to the conductive electrode 182 and the trace 184 through the transparent electrode 190 exposed by the openings 140g, i.e., the first sensing electrodes 150 are further connected to or in direct contact with the transparent electrode 190 through the corresponding openings 140g and are thus electrically connected to the conductive electrode 182 and the trace 184. In this embodiment, the area (or namely vertical projection area) of the openings 140f is greater than the area (or namely vertical projection area) of the openings 140g. As shown in FIG. 11, the insulation layer 140 has a bottom surface 140c that faces the substrate 110, a side wall 140h that defines the opening 140f, and a side wall 140i that defines the opening 140g. An angle θ3 is formed between the side wall 140h and the bottom surface 140c. An angle θ4 is formed between the side wall 140i and the bottom surface 140c. The angle θ3 is smaller than the angle θ4. In other words, the taper angle (i.e., θ3) of the opening 140f corresponding to a larger area is smaller than the taper angle (i.e., θ4) of the opening 140g corresponding to a smaller area. In certain embodiments, the angle θ3 is smaller than 70° and greater than 0°. In one embodiment, the angle θ3 is smaller than 65° and greater than 30°. In one embodiments, the angle θ3 is smaller than 55° and greater than 30°. In certain embodiments, the angle θ3 may be substantially the same as or different from the angle θ1, and the angle θ4 may be substantially the same as or different from the angle θ2.

Referring to FIG. 10, it should be noted that, the conductive electrode 182 is covered by the transparent electrode 190, and the transparent electrode 190 has a part (i.e., the non-overlapping region 190b) extending out of the conductive electrode 182. The openings 140f may be provided above the part (i.e., the non-overlapping region 190b) of the transparent electrode 190 that extends out of the conductive electrode 182. Through the configuration of the transparent electrode 190, the area of the openings 140f for electrically connecting the first sensing electrodes 150 to the trace 184 is not limited by the size of the conductive electrode 182. Thereby, the area of the openings 140f can be designed larger (i.e., the angle θ3 can be designed smaller). Referring to FIGS. 10 and 11, in this way, when the first sensing electrodes 150 are filled in the openings 140f so as to be electrically connected to the trace 184, the first sensing electrodes 150 can be desirably laid on the side wall 140h having a gentle slope. Because the side wall 140h is not prone to collapse, the reliability of the touch panel 100B can be improved.

The inventive spirit of improving the reliability of the touch panel 100B by the use of the transparent electrode 190 can also be applied to the electrical connection relationship between the second sensing electrode series (or namely string) Tx and the trace 184. Descriptions are given below by way of example with reference to other drawings.

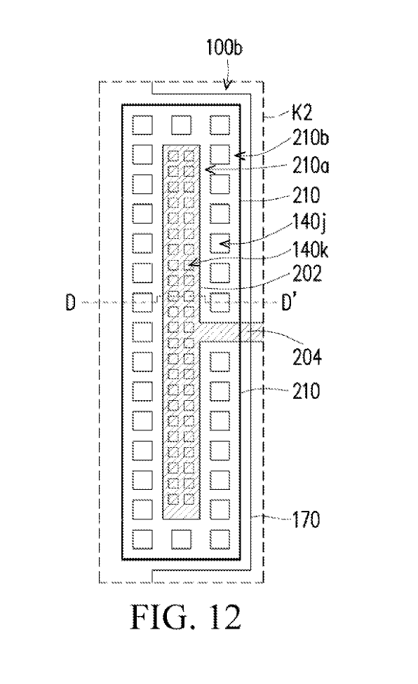

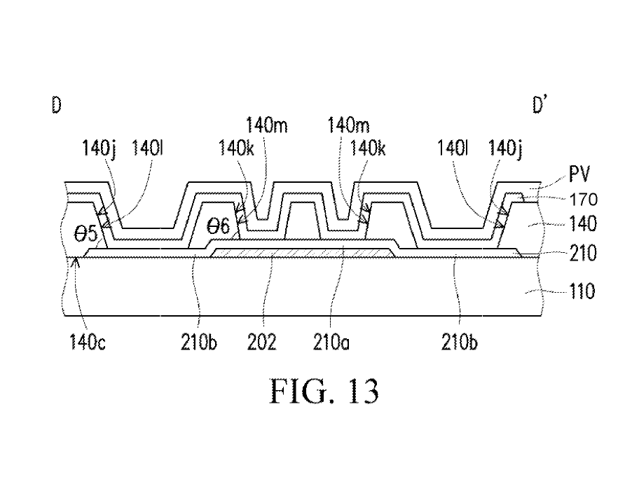

FIG. 12 is a schematic enlarged view of a partial region K2 in FIG. 9. FIG. 13 is a schematic cross-sectional view of the touch panel taken along a cross-sectional line D-D′ in FIG. 12. Referring to FIGS. 9, 12, and 13, the touch panel 100B further includes a conductive electrode 202 and a trace 204 that are located on the peripheral region 110b. The conductive electrode 202 is electrically connected between the second sensing electrode series (or namely string) Tx and the trace 204. In this embodiment, the conductive electrode 202 and the trace 204 may be located in a same film layer and directly connected to each other. Further, the conductive electrode 202, the trace 204, and the first bridge electrodes 120 may be located in a same film layer, but the present disclosure is not limited thereto.

Referring to FIGS. 9, 12, and 13, the touch panel 100B further includes a transparent electrode 210 located on the peripheral region 110b. The transparent electrode 210 covers the conductive electrode 202 and is connected to or in direct contact with the conductive electrode 202. The transparent electrode 210 has an overlapping region 210a that overlaps with the conductive electrode 202 and a non-overlapping region 210b that does not overlap with the conductive electrode 202. The insulation layer 140 further has openings 140j. The openings 140j expose a part of the non-overlapping region 210b of the transparent electrode 210. The second sensing electrodes 170 are filled in the openings 140j, so as to be electrically connected to the conductive electrode 202 and the trace 204 through the transparent electrode 210 exposed by the openings 140j, i.e., the second sensing electrodes 170 are connected to or in direct contact with the transparent electrode 210 through the corresponding openings 140j and are thus electrically connected to the conductive electrode 202 and the trace 204. In this embodiment, the transparent electrode 210 and the transparent electrode 130 are located in a same film layer, but the present disclosure is not limited thereto.

In this embodiment, the insulation layer 140 may selectively further have openings 140k separated from the openings 140j. The openings 140k expose a part of the overlapping region 210a of the transparent electrode 210. The first sensing electrodes 170 are further filled in the openings 140k, so as to be electrically connected to the conductive electrode 202 and the trace 204 through the transparent electrode 210 exposed by the openings 140k, i.e., the first sensing electrodes 170 are further connected to or in direct contact with the transparent electrode 210 through the corresponding openings 140k and are thus electrically connected to the conductive electrode 202 and the trace 204. In this embodiment, the area (or namely vertical projection area) of the openings 140j is greater than the area (or namely vertical projection area) of the openings 140k. As shown in FIG. 13, the insulation layer 140 has a bottom surface 140c that faces the substrate 110, a side wall 140l that defines the opening 140j, and a side wall 140m that defines the opening 140k. An angle θ5 is formed between the side wall 140l and the bottom surface 140c. An angle θ6 is formed between the side wall 140m and the bottom surface 140c. The angle θ5 is smaller than the angle θ6. In other words, the taper angle (i.e., θ5) of the opening 140j corresponding to a larger area is smaller than the taper angle (i.e., θ6) of the opening 140k corresponding to a smaller area. In certain embodiments, the angle θ5 is smaller than 70° and greater than 0°. In one embodiment, the angle θ5 is smaller than 65° and greater than 30°. In one embodiment, the angle θ5 is smaller than 55° and greater than 30°. In certain embodiments, the angle θ5 may be substantially the same as or different from the angle θ1 or the angle θ3, and the angle θ6 may be substantially the same as or different from the angle θ2 or the angle θ4.

Referring to FIG. 12, similarly, through the configuration of the transparent electrode 210, the area (or namely vertical projection area) of the openings 140j for electrically connecting the second sensing electrodes 170 to the trace 204 is not limited by the size of the conductive electrode 202. Thereby, the area of the openings 140j can be designed larger (i.e., the angle θ5 in FIG. 4 can be designed smaller). Referring to FIGS. 12 and 13, in this way, when the second sensing electrodes 170 are filled in the openings 140j so as to be electrically connected to the trace 204, the second sensing electrodes 170 can be desirably laid on the side wall 140l having a gentle slope. Because the side wall 140l is not prone to collapse, the reliability of the touch panel 100B can be improved.

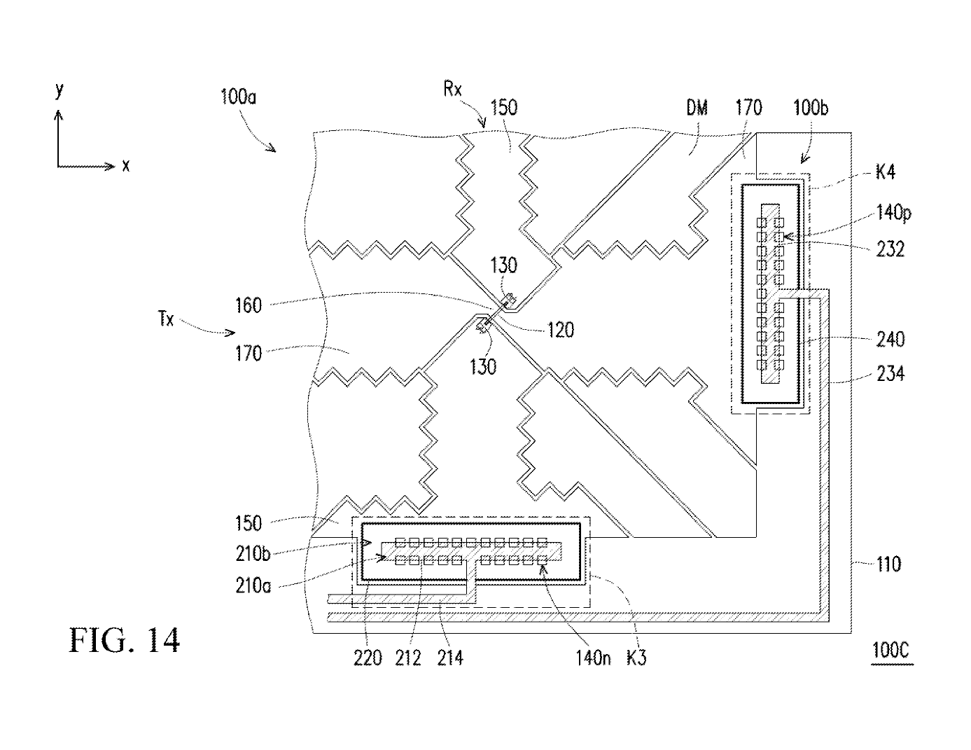

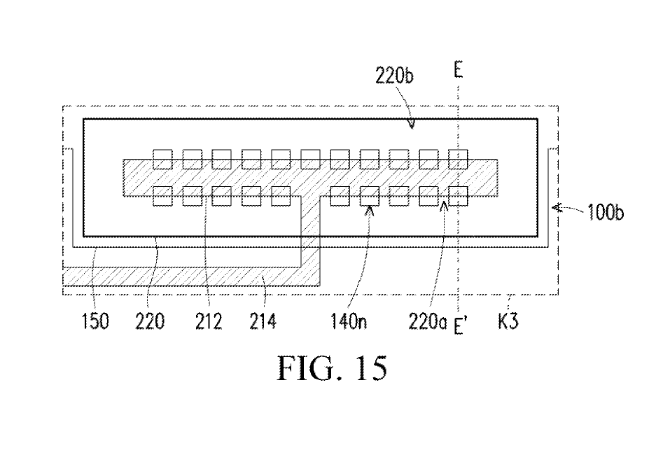

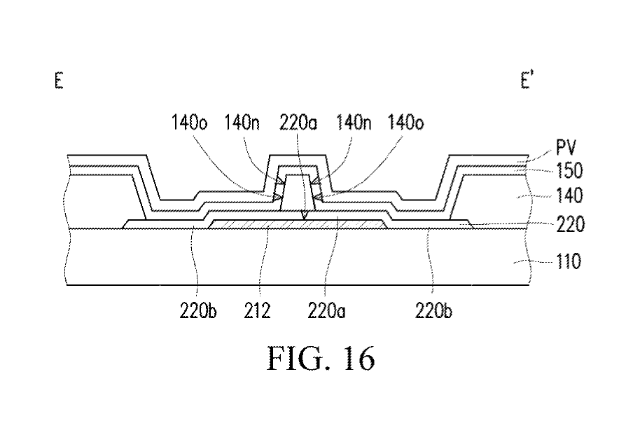

FIG. 14 is a partial schematic view of the touch panel according to an embodiment of the present disclosure. FIG. 15 is a schematic enlarged view of a region K3 in FIG. 14. FIG. 16 is a schematic cross-sectional view of the touch panel taken along a cross-sectional line E-E′ in FIG. 15. Referring to FIGS. 14, 15, and 16, a touch panel 100C includes the first sensing electrode series (or namely string) Rx and the second sensing electrode series (or namely string) Tx that are described above. For the structures of the first sensing electrode string Rx and the second sensing electrode string Tx, reference can be made to the above description, and the details are not described herein again. In addition to the first and second sensing electrode strings Rx and Tx, the touch panel 100C further includes a conductive electrode 212 and a trace 214 that are located on the peripheral region 110b. The conductive electrode 212 is electrically connected between the first sensing electrode string Rx and the trace 214. In this embodiment, the conductive electrode 212 and the trace 214 may be located in a same film layer and directly connected to each other. In certain embodiments, the conductive electrode 212, the trace 214, and the first bridge electrodes 120 may be located in a same film layer, but the present disclosure is not limited thereto.

The touch panel 100C further includes a transparent electrode 220 located on the peripheral region 110b. The transparent electrode 220 covers the conductive electrode 212 and is connected to or in direct contact with the conductive electrode 212. The transparent electrode 220 has an overlapping region 220a that overlaps with the conductive electrode 212 and a non-overlapping region 220b that does not overlap with the conductive electrode 212. The insulation layer 140 further has openings 140n. In this embodiment, the openings 140n expose a part of the non-overlapping region 220b of the transparent electrode 220. The first sensing electrodes 150 are filled in the openings 140n, so as to be electrically connected to the conductive electrode 212 and the trace 214 through the transparent electrode 220 exposed by the openings 140n, i.e., the first sensing electrodes 150 are connected to or in direct contact with the transparent electrode 220 through the corresponding opening 140n and are thus electrically connected to the conductive electrode 212 and the trace 214. In certain embodiments, the transparent electrode 220 and the transparent electrode 130 may be located in a same film layer, but the present disclosure is not limited thereto.

The difference from the touch panel 100B described above lies in that in this embodiment, the openings 140n may expose both a part of the overlapping region 220a and a part of the non-overlapping region 220b of the transparent electrode 220. Thereby, the area (or namely vertical projection area) of the openings 140n may be designed larger, i.e., a side wall 140o of the insulation layer 140 that defines the opening 140n has a gentle slope. Because the side wall 140o and the first sensing electrode 150 laid thereon are not prone to collapse, the reliability of the touch panel 100C can be improved. For the angle formed between the side wall 140o that defines the opening 140n and the bottom surface of the insulation layer 140, reference can be made to the angle θ3 or θ5 in the above embodiments. The angle formed between the side wall 140o that defines the opening 140n and the bottom surface may be substantially the same as or different from the angle θ3 or θ5.

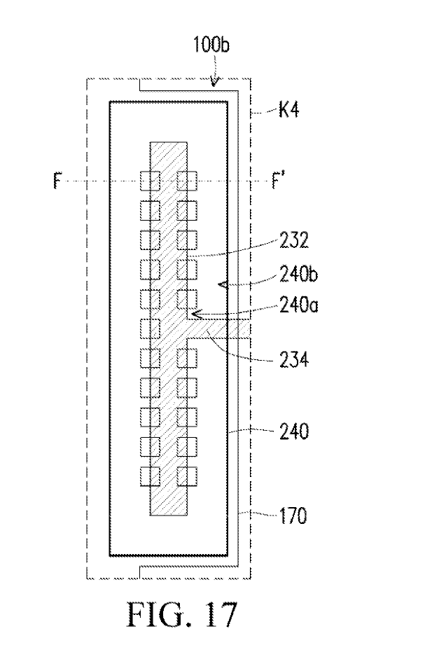

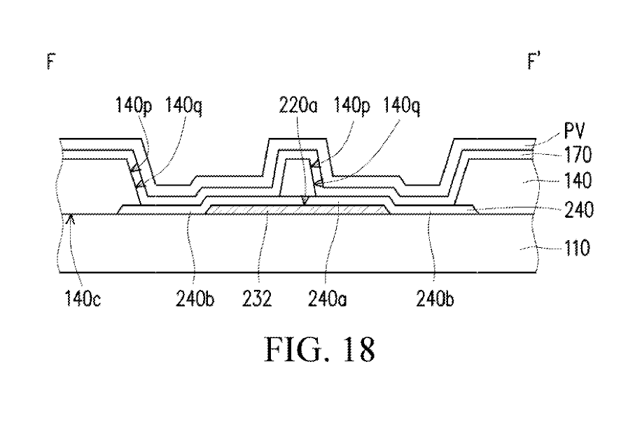

FIG. 17 is a schematic enlarged view of a region K4 in FIG. 14. FIG. 18 is a schematic cross-sectional view of the touch panel taken along a cross-sectional line F-F′ in FIG. 17. Referring to FIGS. 14, 17, and 18, the touch panel 100C further includes a conductive electrode 232 and a trace 234 that are located on the peripheral region 110b. The conductive electrode 232 is electrically connected between the second sensing electrode series (or namely string) Tx and the trace 234. In this embodiment, the conductive electrode 232 and the trace 234 may be located in a same film layer and directly connected to each other. In certain embodiments, the conductive electrode 232, the trace 234, and the first bridge electrodes 120 may be located in a same film layer, but the present disclosure is not limited thereto.

Referring to FIGS. 14, 17, and 18, the touch panel 100C further includes a transparent electrode 240 located on the peripheral region 110b. The transparent electrode 240 covers the conductive electrode 232 and is connected to or in direct contact with the conductive electrode 232. The transparent electrode 240 has an overlapping region 240a that overlaps with the conductive electrode 232 and a non-overlapping region 240b that does not overlap with the conductive electrode 232. The insulation layer 140 further has openings 140p. The openings 140p expose a part of the non-overlapping region 240b of the transparent electrode 240. The second sensing electrodes 170 are filled in the openings 140p, so as to be electrically connected to the conductive electrode 232 and the trace 234 through the transparent electrode 240 exposed by the openings 140p, i.e., the second sensing electrodes 170 are connected to or in direct contact with the transparent electrode 240 through the openings 140p and are thus electrically connected to the conductive electrode 232 and the trace 234. In this embodiment, the openings 140p may expose both a part of the overlapping region 240a and a part of the non-overlapping region 240b of the transparent electrode 240. Thereby, the area (or namely vertical projection area) of the openings 140p may be designed larger, i.e., a side wall 140q of the insulation layer 140 that defines the opening 140p has a gentle slope. Because the side wall 140q and the second sensing electrodes 170 laid thereon are not prone to collapse, the reliability of the touch panel 100C can be improved. For the angle formed between the side wall 140q that defines the opening 140p and the bottom surface 140c of the insulation layer 140, reference can be made to the angle θ3 or θ5 in the above embodiments. In certain embodiments, the angle formed between the side wall 140q that defines the opening 140p and the bottom surface 140c may be substantially the same as or different from the angle θ3 or θ5, and the angle formed between the side wall 140q that defines the opening 140p and the bottom surface 140c may also be substantially the same as or different from the angle formed between the side wall 140o that defines the opening 140n and the bottom surface 140c of the insulation layer 140. In certain embodiments, the above multiple embodiments of the present disclosure can be applied to a touch panel individually or in combination. In certain embodiments, the areas (or namely vertical projection area) of the transparent electrodes 130, 190, 210, 220, and 240 in the above embodiments are preferably all smaller than at least one of the areas (or namely vertical projection area) of the first sensing electrodes 150 and the second sensing electrodes 170 (according to a combination of the above multiple embodiments). For example, the area of the transparent electrode 130 is smaller than the area of the first sensing electrodes 150, the area of the transparent electrode 190 is smaller than the area of the first sensing electrodes 150, the area of the transparent electrode 210 is smaller than the area of the second sensing electrodes 170, the area of the transparent electrode 220 is smaller than the area of the first sensing electrodes 150, and/or the area of the transparent electrode 240 is smaller than the area of the second sensing electrodes 170.

Based on the above, in the touch panel according to one embodiment of the present disclosure, two ends of each of the first bridge electrodes are respectively covered by two transparent electrodes, and each of the transparent electrodes has a part extending out of the first bridge electrode. The openings are provided above the part of the transparent electrode that extends out of the first bridge electrode. Through the configuration of the transparent electrodes, the area (or namely vertical projection area) of the openings for electrically connecting two neighboring first sensing electrodes is not limited by the size of the first bridge electrode. Thereby, the area of the openings can be designed larger, i.e., the side wall that defines the opening can be designed to have a gentle slope. In this way, when two neighboring first sensing electrodes are filled in the openings and electrically connected to each other, the first sensing electrodes can be desirably laid on the side wall having a gentle slope. Because the side wall and the first sensing electrodes laid on the side wall are not prone to collapse, the reliability of the touch panel can be improved.

In the touch panel according to another embodiment of the present disclosure, the touch panel includes a trace located in the peripheral region and a conductive electrode located in the peripheral region and electrically connected to the trace. The conductive electrode is used to be electrically connected to the first sensing electrodes of the first sensing electrode string or the second sensing electrodes of the second sensing electrode string. The touch panel further includes a transparent electrode. The transparent electrode covers the conductive electrode and has a part extending out of the conductive electrode. The openings can be provided above the part of the transparent electrode that extends out of the conductive electrode. Through the configuration of the transparent electrode, the area (or namely vertical projection area) of the openings for electrically connecting the first sensing electrodes (or the second sensing electrodes) to the trace is not limited by the size of the conductive electrode. Thereby, the area of the openings may be designed larger, i.e., the side wall that defines the opening can be designed to have a gentle slope. In this way, when the first sensing electrodes (or the second sensing electrodes) are filled in the openings and electrically connected to the trace, the first sensing electrodes (or the second sensing electrodes) can be desirably laid on the side wall having a gentle slope. Because the side wall is not prone to collapse, the reliability of the touch panel can be improved.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A touch panel, comprising:
a substrate, having a touch region and a peripheral region surrounding the touch region;
a plurality of first bridge electrodes, disposed on the touch region of the substrate;
a plurality of first transparent electrodes, separated from each other and disposed on the touch region of the substrate, wherein two neighboring first transparent electrodes respectively cover two ends of a corresponding one of the first bridge electrodes and are electrically connected to the corresponding one of the first bridge electrodes, each of the first transparent electrodes has a first overlapping region that overlaps with the corresponding one of the first bridge electrodes and a first non-overlapping region that does not overlap with the corresponding one of the first bridge electrodes;
a first insulation layer, covering the first bridge electrodes, the first transparent electrodes, and the substrate, wherein the first insulation layer has a plurality of first openings, and two neighboring first openings respectively expose a part of the first non-overlapping regions of corresponding two neighboring first transparent electrodes of the first transparent electrodes;
a plurality of first sensing electrodes, disposed on the first insulation layer and located on the touch region of the substrate, wherein two neighboring first sensing electrodes respectively overlap with two ends of corresponding one of the first bridge electrodes and corresponding two neighboring first transparent electrodes, and the two neighboring first sensing electrodes are respectively filled in the first openings and are electrically connected to each other through the first transparent electrodes exposed by the first openings and the corresponding one of the first bridge electrodes, so as to form a first sensing electrode series extending in a first direction;
a plurality of second bridge electrodes, disposed on the first insulation layer and located on the touch region of the substrate, wherein the second bridge electrodes respectively cross the first bridge electrodes; and
a plurality of second sensing electrodes, disposed on the first insulation layer, and located on the touch region of the substrate, wherein two neighboring second sensing electrodes are respectively connected to two ends of a corresponding one of the second bridge electrodes, so as to form a second sensing electrode series extending in a second direction, and the first direction intersects with the second direction.

2. The touch panel according to claim 1, wherein the first insulation layer further has a plurality of second openings separated from the first openings, two neighboring second openings respectively expose a part of the first overlapping regions of the first transparent electrodes, and the first sensing electrodes are further filled in the second openings respectively, so as to be electrically connected to each other through the first transparent electrodes exposed by the second openings and the corresponding one of the first bridge electrodes.

3. The touch panel according to claim 2, wherein an area of each of the first openings is greater than an area of each of the second openings.

4. The touch panel according to claim 2, wherein the first insulation layer has a bottom surface that faces the substrate, a first side wall that defines the first opening, and a second side wall that defines the second opening, a first angle is formed between the first side wall and the bottom surface, a second angle is formed between the second side wall and the bottom surface, and the first angle is smaller than the second angle.

5. The touch panel according to claim 1, wherein each of the first openings exposes the first overlapping region and the first non-overlapping region of the corresponding one of the first transparent electrodes.

6. The touch panel according to claim 1, further comprising:
a conductive electrode and a trace, located on the peripheral region, wherein the conductive electrode is electrically connected between the first sensing electrode series and the trace or is electrically connected between the second sensing electrode series and the trace; and
a second transparent electrode, located on the peripheral region, wherein the second transparent electrode covers the conductive electrode and is electrically connected to the conductive electrode, and the second transparent electrode has a second overlapping region that overlaps with the conductive electrode and a second non-overlapping region that does not overlap with the conductive electrode,
wherein the first insulation layer further has a third opening, the third opening exposes a part of the second non-overlapping region of the second transparent electrode, and the first sensing electrode or the second sensing electrode is filled in the third opening, so as to be electrically connected to the trace through the second transparent electrode exposed by the third opening and the conductive electrode.

7. The touch panel according to claim 6, wherein the first insulation layer further has at least one fourth opening separated from the third opening, the fourth opening exposes a part of the second overlapping region of the second transparent electrode, and the first sensing electrode or the second sensing electrode is further filled in the fourth opening, so as to be electrically connected to the trace through the second transparent electrode exposed by the fourth opening and the conductive electrode.

8. The touch panel according to claim 7, wherein an area of the third opening is greater than an area of the fourth opening.

9. The touch panel according to claim 7, wherein the first insulation layer has a bottom surface that faces the substrate, a third side wall that defines the third opening, and a fourth side wall that defines the fourth opening, a third angle is formed between the third side wall and the bottom surface, a fourth angle is formed between the fourth side wall and the bottom surface, and the third angle is smaller than the fourth angle.

10. The touch panel according to claim 6, wherein the third opening exposes the second overlapping region and the second non-overlapping region of the second transparent electrode.

11. A touch panel, comprising:
a substrate, having a touch region and a peripheral region surrounding the touch region;
a conductive electrode and a trace, disposed on the peripheral region of the substrate, wherein one end of the trace is connected to the conductive electrode;
a transparent electrode, disposed on the peripheral region of the substrate, wherein the transparent electrode covers the conductive electrode and is electrically connected to the conductive electrode, and the transparent electrode has an overlapping region that overlaps with the conductive electrode and a non-overlapping region that does not overlap with the conductive electrode;
a first insulation layer, covering the conductive electrode, the trace, the transparent electrode, and the substrate, wherein the first insulation layer has a first opening, and the first opening exposes a part of the non-overlapping region of the transparent electrode;
a bridge electrode, disposed on the first insulation layer and located on the touch region of the substrate; and
a plurality of sensing electrodes, disposed on the first insulation layer and located on the touch region of the substrate, wherein one of the sensing electrodes corresponding to the conductive electrode is filled in the first opening, so as to be electrically connected to the trace through the transparent electrode exposed by the first opening and the conductive electrode, and two neighboring sensing electrodes are connected through the bridge electrode, so as to form a sensing electrode series.

12. The touch panel according to claim 11, wherein the first insulation layer further has a second opening separated from the first opening, the second opening exposes the overlapping region of the transparent electrode, and one of the sensing electrodes corresponding to the conductive electrode is further filled in the second opening, so as to be electrically connected to the trace through the transparent electrode exposed by the second opening and the conductive electrode.

13. The touch panel according to claim 12, wherein an area of the first opening is greater than an area of the second opening.

14. The touch panel according to claim 12, wherein the first insulation layer has a bottom surface that faces the substrate, a first side wall that defines the first opening, and a second side wall that defines the second opening, a first angle is formed between the first side wall and the bottom surface, a second angle is formed between the second side wall and the bottom surface, and the first angle is smaller than the second angle.

15. The touch panel according to claim 11, wherein the first opening exposes the overlapping region and the non-overlapping region of the transparent electrode.
